(19) United States
(12) Patent Application Publication
(10) Pub. No.: US 2021/0406784 A1
(43) Pub. Date: Dec. 30, 2021

(54) METHOD FOR REGULATING A MULTIMODAL TRANSPORT NETWORK

(71) Applicant: COSMO TECH, Lyon (FR)

(72) Inventors: Yunfei ZHA, Shanghai (CN); Oussama ALLALI, Palaiseau (FR); Thomas LACROIX, Lyon (FR)

(21) Appl. No.: 17/280,674

(22) PCT Filed: Jul. 30, 2019
(86) PCT No.: PCT/FR2019/051872

§ 371 Date: Mar. 26, 2021

(30) Foreign Application Priority Data
Sep. 26, 2018 (FR) 18/58783

(51) Int. Cl. G06Q 10/02; G06Q 50/30; G07C 5/08

(52) U.S. Cl. CPC G06Q 10/025; G07C 5/0808; G06Q 50/30

(57) ABSTRACT

A method for determining at least one performance indicator of a multi-modal transport network including the following steps: for each transport mode of the at least one transport mode, determining a current state of the transport mode, simulating a future state, carrying out an evaluation of the at least one performance indicator, determining at least one regulatory action, carrying out a new simulation of a new future state, for the future time, based on the current state, for the current time, carrying out a new evaluation of the at least one performance indicator of the transport mode based on the new future state, comparing the result of the new evaluation and the evaluation, repeating the steps until a result of the comparison indicates an improvement in the at least one performance indicator.

### CROSS REFERENCE TO RELATED APPLICATIONS

This application is a National Stage of PCT Application No. PCT/FR2019/051872 filed on Jul. 30, 2019, which claims priority to French Patent Application No. 18/58783 filed on Sep. 26, 2018, the contents each of which are incorporated herein by reference thereto.

### TECHNICAL FIELD

The present invention is intended for experts of public transportations regulation. It aims at enabling the transport operator to anticipate the traffic of the streams of different transportation modes (bus, metro, train, tramway, etc.) while taking into account in real-time congestions and incidents throughout their network as well as the adjacent networks (road network) in order to influence the selections of itineraries of the passengers and to regulate the services offering for a better traffic.

### BACKGROUND

Nowadays, transport operators use single-mode regulation solutions (which relate to one single transportation mode and even to one single line), as is the case with the operational support system (OSS) for buses and tramways or else the Automatic Train Supervision (ATS) for trains. These systems are developed by the same manufacturers who deploy the infrastructures of these transportation modes or by independent software editors. Yet, the passenger viewpoint (probability of arrival on time and comfort) is not taken into account in this type of tools

In capital cities where the urban network is dense and diverse, multimodal systems have been set in place. The user of the public transport network can find the itinerary that best suits him according to a multi-criteria search. However, information is not supplied to him in real-time and according to the traffic difficulties that could arise during his trip. The solutions that are currently on the market do not allow anticipating the probability for the user to arrive on time. This possibility exists in road usage with online platforms providing consumer applications which enable the user and depending on his vehicle to make the best itinerary choice as a function of the traffic in real-time.

The current difficulty lies in modeling of the multimodal system as a whole. A multimodal system comprises physical infrastructures, interconnections, a fleet, scheduling rules, operational monitoring and passengers. Each of these elements has specific constraints and behaviors and it is quite complex to consider the whole. For example, one shall take into account the behavior of the different types of passengers according to the various incidents and disturbances that might occur while informing them quickly on the new re-routing possibilities. This is in order to avoid an excessively huge congestion and a dissatisfaction of the clients due to delays that turn out to be even more problematic when these imply the loss of a connection. Besides, the mobility policies of the authorities on which the network depends shall be applied.

Hence, the optimization of the multimodal itineraries shall be based not only on the interconnection of the different lines and transportation modes but also on the calculation of uncertainty of the transit time while taking into account all of the constraints of the system. The aim is also to reduce the calculation time to enable the operators to set up solutions (adding buses on the lines x and y to relieve a given metro line blocked by an incident . . . ) and so as quickly as possible.

Hence, the invention aims at providing a solution to all or part of these problems.

### BRIEF SUMMARY

To this end, the present invention concerns a method for determining at least one performance indicator of a transport network, the transport network being used by a plurality of passengers of the network and the transport network comprising at least one transportation mode, each transportation mode of the at least one transportation mode comprising at least one vehicle and a plurality of stations, a start station of the plurality of stations of the at least one transportation mode being connected by a plurality of itineraries, each itinerary of the plurality of itineraries comprising a list of intermediate stations of the plurality of stations, to a destination station of the plurality of stations, a timetable of the at least one transportation mode defining a check-in time of the at least one vehicle at the start station, at the destination station, and at each station of the list of intermediate stations of the itinerary, the plurality of passengers of the network comprising, for each station of the plurality of stations of the at least one transportation mode, a number of passengers waiting at the station, the number of passengers waiting at the station being determined from data captured by at least one data collection instrument, a start-destination matrix defining, for a period of time, and for a pair formed by the start station and the destination station, an additional number of passengers who will come into the network via the start station, over the period of time, to join the destination station,

the method comprising the following steps:

for each transportation mode of the at least one transportation mode,
determination of a current state of the transportation mode defined for a current time within the period of time;
simulation of a future state, for a future time, of the transportation mode based on the current state, and of the additional number of passengers who will come into the network over the period of time according to the start-destination matrix;
assessment of the at least one performance indicator based on the future state of the transportation mode;
determination of at least one regulatory action on the at least one transportation mode as a function of the assessment of the at least one indicator;
new simulation of a new future state, for the future time, based on the current state, for the current time, and on the additional number of passengers who will come into the network over the period of time according to the start-destination matrix;
new simulation of the at least one performance indicator of the transportation mode based on the new future state;
comparison of the result of the new assessment and of the assessment of the at least one performance indicator;
repetition of the steps of determination of at least one regulatory action, of new simulation, of new assessment and of comparison until a result of the comparison indicates an improvement of the at least one performance indicator,

the simulation of the future state and the new simulation of the new future state being respectively carried out, for at least one intermediate time between the current time and the future time, by distributing over the plurality of itineraries joining the start station and the destination station, according to a predetermined distribution procedure, the number of passengers waiting at said start station to join said destination station, added to the estimated additional number, for said start station and for a period of time including the at least one intermediate time, based on the start-destination matrix.

According to these arrangements, the top operator of the multimodal transport network can determine the suitable regulatory action(s) to improve at least one performance indicator of the network, in view of the predicted effect of the regulatory action(s).

If the regulatory actions turn out to have a satisfactory predicted effect on the performance indicator(s), then these actions may be implemented by the operator of the multimodal network, so as to effectively improve the performance of the network in accordance with the determined indicators.

According to these arrangements, the method allows assisting the operator of the multimodal network to better plan his multimodal mobility offering to better respond to the dynamic evolution of the mobility streams, thereby allowing improving the overall punctuality of the service, while considering the viewpoint of the passenger (the arrival time rather than the departure/arrival time of the transport vehicle), while enabling the operator to test the impact of regulatory scenarios on the mobility system.

According to one implementation mode, the invention comprises one or more of the following features, considered separately or in combination.

According to one implementation mode, the predetermined distribution procedure is carried out based on a passenger-profile associated to each passenger of the plurality of passengers waiting at said start station, and as a function of an intermediate state of the network defined at the intermediate time.

According to one implementation mode, the passenger-profile associated to each passenger of the plurality of passengers is defined by travel preferences.

According to one implementation mode, the passenger-profiles and the passenger-destinations of the waiting passengers are predetermined for each transportation mode, based on a history of statistical data built from simulations of several typical days for each of the stations of this transportation mode and at different times of the day.

According to one implementation mode, a passenger-itinerary is associated to each passenger of the plurality of passengers waiting at said start station, the passenger-itinerary being determined as a function of the passenger-profile.

According to one implementation mode, the predetermined distribution procedure is a multimodal dynamic assignment procedure.

According to one implementation mode, the at least one data collection instrument is a sensor, or a statistical data learning application, or a remote tickets purchase ticketing application.

According to one implementation mode, for each pair formed by a start station and a destination station, an optimum distribution of the plurality of passengers waiting at the start station, including the additional number estimated for said start station based on the start-destination matrix, on the different itineraries joining the start station to the destination station, is determined according to a multimodal dynamic assignment procedure, so that a transit time is optimum for the plurality of passengers waiting at said start station, the travel time being estimated based on the plurality of itineraries joining the start station and the destination station.

According to one implementation mode, a transit time is optimum if it is at minimum. According to one implementation mode, the optimization of the determination of the itineraries seeks an arrival at destination that is the soonest for the passengers, for each of the destinations and for statistically predetermined passenger-profiles as indicated before.

According to one implementation mode, the current state of the transportation mode is defined by at least one parameter, the at least one parameter comprising one amongst:
a number of passengers waiting at the stations of the plurality of stations of the transportation mode,
a position and a load of the at least one vehicle of the transportation mode, and
a distribution by passenger-profile, of the number of passengers waiting at the stations of the plurality of stations of the transportation mode,

and a value is determined by the at least one data collection instrument, or estimated, for each parameter of the at least one parameter, at the determination step.

According to one implementation mode, the passenger-itinerary comprises a list of stations, each station of said list being a station of the plurality of stations of the at least one transportation mode, and each station of said list being determined as a function of the check-in time of the at least one vehicle of each transportation mode of the at least one transportation mode at the stations of the plurality of stations of each transportation mode of the at least one transportation mode, and so as to optimize the check-in time at the passenger-destination, and as a function of the passenger-profile.

According to one implementation mode, the method is implemented on a regular basis, for example every 5 minutes, and the future time of the simulated future state and the current time of the current state are shifted over time, for example by one hour. Thus, every 5 minutes, a step of determining a current state of each transportation mode of the network is initiated, and then a future state is simulated for a future time shifted over time, for example by one hour, with respect to the current time of the current state; thus the simulated future state of the network will be the predicted state one hour later after gathering of field information and estimation of the information relating to the current state, and the new simulated future state will also correspond to a predicted state of the network one hour after gathering of field information and estimation of the information relating to the current state, with regards to the regulatory actions determined by the method.

According to these arrangements, the method is based on a fine and detailed simulation (respectively a new simulation) of a future state (respectively of a new future state), according to intermediate time steps that may be very short, typically about one second, for example.

The field data that serve as a basis for the establishment of the current state and then for the simulation (respectively for the new simulation) consist of real-time information, gathered on the field by the data collection instrument just before the beginning of the simulation and new simulation steps, and therefore keeping up with the most recent evolutions of the network.

According to one implementation mode, the at least one transportation mode comprises at least one of the transportation modes amongst the transportation modes: by road, by rail, by air, by inland waterways, by sea.

According to one implementation mode, the transportation modes by road, by air, and by inland waterways respectively comprise at least one of the transportation modes amongst: the private transportation mode and the public transportation mode.

According to one implementation mode, the at least one performance indicator of the transportation network comprises at least one of the indicators: punctuality, regularity, occupancy rate, waiting time, trip duration.

According to one implementation mode, the punctuality indicator enables the operator of the network to assess, over the simulation period, the advance or the delay of the vehicles with regards to the check-in times scheduled by the operator.

According to one implementation mode, the regularity indicator enables the operator of the network to assess, over the simulation period, the estimated interval between the vehicles that circulate along the same itinerary and to compare this interval with a nominal interval.

According to one implementation mode, the occupancy rate indicator enables the operator to assess, over the simulation period, the comfort of the passengers by comparing this estimated occupancy rate or load with a nominal occupancy rate or load.

According to one implementation mode, the waiting time indicator enables the operator of the network to assess, over the simulation period, the estimated average waiting time of the passengers at each station of the network.

According to one implementation mode, the trip duration indicator enables the operator of the network to assess the average trip duration between a departure station and an arrival station.

According to one implementation mode, the performance indicators are calculated for different time points comprised between the current period of time and the future period of time. For example, every 15 minutes, a value of the performance indicators will be estimated; thus 4 different values for each indicator will be estimated between the current period of time of the current state and the future period of time of the simulated future state, shifted, in this example, by one hour from the current period of time of the current state.

According to one implementation mode, the at least one regulatory action of the transportation mode comprises at least one of the actions amongst:
add a vehicle,
modify an itinerary of a vehicle to go from one station of the plurality of stations to another station of the plurality of stations of the transportation mode,
modify a check-in time of the at least one vehicle at a station of the plurality of stations,
close a station fora while,
set up a replacement bus,
close a section for a while,
reduce the rate,
add a station, and
delete a stop.

According to one implementation mode, the simulation of the future state and the new simulation of the new future state is carried out based on a vehicle-itinerary and on a vehicle-behavior model of the at least one vehicle,

and wherein the vehicle-behavior model of the at least one vehicle is defined by a plurality of vehicle-states of the at least one vehicle and by at least one vehicle-state change rule to make the at least one vehicle switch from an initial vehicle-state into a next vehicle-state of the plurality of vehicle-states of the at least one vehicle, and wherein the vehicle-itinerary of the at least one vehicle comprises a subset of stations of the plurality of stations of the transportation mode of the at least one transportation mode, the subset of stations comprising a departure station, intermediate stations, a terminus station and, optionally, at least one intermediate itinerary to go from one station of the subset of stations to the station.

According to one implementation mode, the plurality of vehicle-states of the at least one vehicle comprises one of the vehicle-states amongst:
vehicle at stop by a signal,
vehicle moving,
vehicle at stop by a station,
vehicle being loaded,
vehicle being closed,
vehicle arrived at the terminus,

and wherein the at least one vehicle-state change rule of the at least one vehicle comprises at least one safety rule and at least one rule for determining a displacement speed.

According to one implementation mode, the simulation of the future state and the new simulation of the new future state is carried out based on a passenger-behavior model of the plurality of passengers of the transportation mode, the passenger-behavior model of the plurality of passengers being defined by a plurality of passenger-states of the at least one passenger and by at least one passenger-state change rule for making the at least one passenger switch from an initial state into a next state of the plurality of passenger-states of the plurality of passengers.

According to one implementation mode, the transport network comprises at least one connection between a transportation mode and another transportation mode of the at least one transportation mode, the connection being defined by a connection station of the plurality of stations of the transportation mode of the at least one transportation mode, towards another connection station of the plurality of stations of the other transportation mode of the at least one transportation mode,

and the plurality of passenger-states of the at least one passenger comprises one of the passenger-states amongst:
waiting at station,
onboard,
walking in transit,
boarding,
descending,
arrived at destination,

and, optionally, the at least one passenger-state change rule of the at least one passenger comprises at least one walking speed determination rule conditioned by the passenger-profile of the at least one passenger.

### BRIEF DESCRIPTION OF THE DRAWINGS

For a better understanding, the invention is described with reference to the appended drawings representing, as a non-limiting example, an embodiment of a device according to the invention. The same reference numerals on the drawings refer to similar elements or elements whose functions are similar.

FIG. 1 is a schematic flowchart of the steps of the method according to the invention.

FIG. 2 is a schematic representation of a vehicle behavior model.

FIG. 3 is a schematic representation of a passenger behavior model.

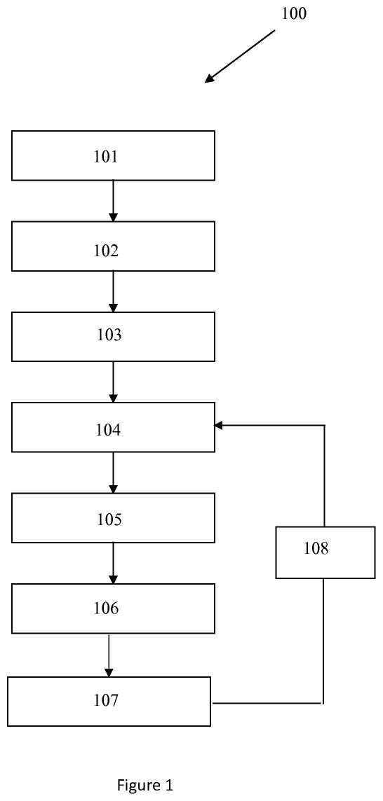

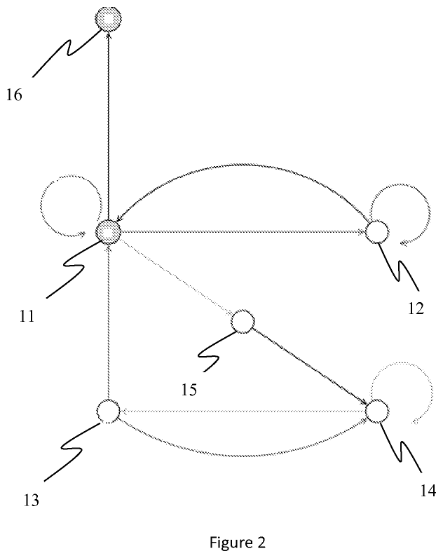

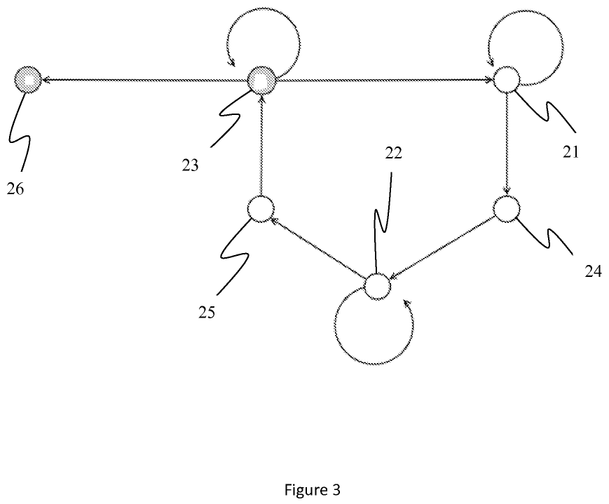

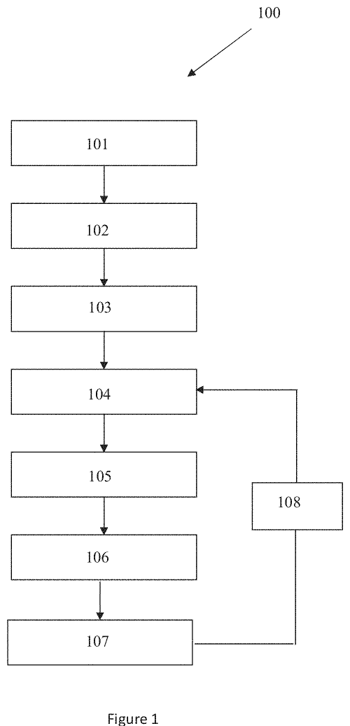

### DETAILED DESCRIPTION

The method 100 according to the invention concerns a multimodal transport network, that is to say a transport network comprising one or several transportation mode(s): the transport network may comprise for example a transportation mode by rail, and/or a transportation mode such as subway metro, and/or a transportation mode such as tramway, each with different train or metro or tramway lines, and even a transportation mode by road such as a private vehicle and/or a bus, with several itineraries and/or several bus lines. The network may also comprise air, and even sea or inland waterways, transportation modes.

Hence, each transportation mode comprises one or several line(s) or itinerary(y/ies). Each line or itinerary of a transportation mode comprises several stops or stations, including a departure station and an arrival station. One or several vehicle(s) are assigned to these different lines and configured to be move along these lines, between the departure station of one line and the terminal station of the line, while stopping at all or part of the intermediate stations of the line at schedules programmed by an operator.

The users are passengers who get into the vehicles that stop at a station and who descend when they reach the end destination of their itinerary, or when they reach an intermediate destination of their itinerary.

There are connections for enabling the passengers of one line of a transportation mode to join another line of the same transportation mode or of another transportation mode, thanks to a link, by foot in general, between a station of said line and another station of said other line.

Information on the field are gathered by different collection instruments positioned so as to measure different parameters related to the different transportation modes; these collection instruments allow gathering information on the field to determine:
the number of passengers waiting at each station;
the number of passengers who get into and/or who descend from a vehicle;
the position of the vehicles at all times.

These collection instruments may be positioned, for example:
at the stop stations of the vehicles, to count the passengers waiting at each station;
in the vehicles and/or at the entrance of the vehicles, to count the passengers who get in and/or who descend;
on the vehicles to measure the respective position at all times of each of the vehicles.

These collection instruments may consist of sensors, learning applications based on statistical data, or ticketing applications for remote tickets purchase.

Other information related to each of the transportation modes, such as for example the tables summarizing the programmed schedules of the stops of the different vehicles at the different stations of each line or itinerary of the considered transportation mode, are supplied by the operator in the form of timetables for this transportation mode. Thus, for each vehicle and each station of the different lines of this transportation mode, the timetables comprise:
an itinerary of the vehicle, in the form of a list of intermediate stations, to go from a start station to a destination station of the same transportation mode;
an expected check-in time of the vehicle at the start station, at the destination station, and at each intermediate station of the list of stations of the itinerary between the start station and the destination station.

Other information related to the future arrivals of the passengers at departure stations to get to different arrival stations, are also available in the form of a start-destination matrix and describe the distribution of a predicted overall stream of new passengers of the multimodal network, over a determined period of time, between the different available pairs formed by a departure station, or start station, of a transportation mode and an arrival station, or destination station, of the same transportation mode or of another transportation mode.

Besides, at any time, it is possible to estimate other parameters specific to each transportation mode, for example:
an estimated number of additional passengers added to the passengers waiting at the stations of the transportation mode, over a predetermined period of time,
an estimated load in a vehicle of the transportation mode,
an estimated distribution of passengers between different destinations selected from the stations of the different transportation modes of the multimodal network.

At all times, a current state of a transportation mode is defined by a value of at least one parameter of the transportation mode, said value being measured by a sensor or a data collection instrument, or read on a server, or estimated.

The method 100 comprises a first step 101 of determining, for each transportation mode of the multimodal network, the current state thus defined of the transportation mode.

According to one implementation mode, a current state of each transportation mode is determined on a regular basis, according to a relatively short periodicity, for example every 5 minutes.

The method 100 includes a step 102 of simulating, in a fine and detailed manner, a future state of each transportation mode, based on the current state of the transportation mode and on a start-destination matrix for the period of time corresponding to the time point considered for the determination of the current state.

According to one implementation mode, the simulation step 102 simulates a future state which is a forecast of the evolution of the state of the network after a forecasting period, defined as an elapsed time between the time point considered for the determination of the current state and the time point considered for the determination of the future state; the duration of the forecasting period will be, for example, according to an implementation mode, one hour after the determination of the current state.

Thus, according to one implementation mode, the method 100 will allow forecasting, based on the current state as determined substantially every 5 minutes, the forecasted future state one hour after the determination of said current state.

According to one implementation mode, the simulation 102 involves one or several model(s) which describe the behavior of the different constituent elements of the multimodal transport network, including the passengers of the network, and which describe the interactions between these different elements. In order to simulate, in a fine and detailed manner, a future state, for example one hour after the determined current state, the simulation 102 simulates the evolution over one hour of the state of each component of the transport system, including the passengers, and the interactions between these components and the passengers, according to a very fine step, for example every second.

According to one implementation mode, the simulation step 102 simulates the progress of the passengers in the connections, represented for example in the form of corridors between the stations which are thus connected.

According to an implementation mode of the simulation 102, the passengers are treated according to their profile, the profile of the passengers may be characterized by a travel preference, this travel preference being associated to a travel coefficient for each transportation mode, the travel coefficient being determined for example by an age of the passengers, a gender of the passengers, and/or a socio-professional category of the passengers. According to one implementation mode, the simulation 102 considers an assumption on the distribution of the passengers according to their profile.

According to one implementation mode, the simulation of the movement of the passengers in the corridors of the connections takes into account the profile of the passengers. The assumption on the distribution of the passengers according to their profile is applied to the numbers of passengers estimated according to the lastly determined current state of the transportation mode, for the stations of a determined connection in order to estimate a movement of the passengers in the corridor between the stations of the connection and, where appropriate, also as a function of complementary characteristics of the considered corridor.

This allows obtaining an estimate of the transit time through the corridor for each passenger. If the density of passengers is high, the transit time may be longer, which is likely to cause a delay of the considered passenger(s) with regards to the transit that is desired by these.

This delay, related to a poorly controlled load in the network, will result in an impact on the forecasted future state and on the performance indicators of the considered transportation modes of the network, which performance indicators will be assessed at the next step of the method. This impact will enable a top operator of the network, assisted by the tool implementing the method 100, to determine suitable regulatory actions.

According to one implementation mode, in the same manner as the simulation step 102 simulates the progress of the passengers in the connections, the simulation step 102 also simulates the interactions between the passengers and the vehicles that arrive at the stations. When the vehicle arrives at a station, two interactions take place, (1) passengers who get into the vehicle (2) passengers who descend from the vehicle. The vehicle will remain at the stop as long as its waiting time will be different from zero. Several phenomena intervene in the calculation of the waiting time. There may be a minimum stop time, a soonest departure schedule or an inadvertent blocking of the doors. This time will enable a selection of passengers to descend and then get onboard. Once this time falls to 0, an attempt for departure and closure of the doors is performed. In the case where it would not be possible to advance (an object in the physical infrastructure of the line prevents its advance for example), the vehicle remains by the platform, and the doors remain open.

An inadvertent blocking of a door in a train may have an impact on the progress of the trains that pass through the same station (the trains must maintain a minimum safe distance). This may have a domino effect leading to the constitution of a wait queue which forms thereby generating a delay on several vehicles.

The blocking of the doors is due to an entry and/or exit streams of passengers that is/are not controlled or not forecasted. Being able to foresee this phenomenon before it happens is a major concern: this enables an operator to increase his responsiveness to the problems in order to be able to apply regulatory actions to take off the load from the most loaded spot of the network. Besides, this enables an operator to measure the magnitude of the problem in order to have reliable information on the time for resuming normal operation.

According to one implementation mode, in the same as the simulation step 102 simulates the progress of the passengers in the connections, and the interactions between the passengers and the vehicles that arrive at the stations, the simulation step 102 also simulates the movement of each vehicle in two environments, a logical environment and a physical environment. The logical environment represents the network as it could be seen by the passenger or presented by the transport offering. Thus, the stations may be connected together by connections or by sections. The connections correspond to the transit corridors between the stations, whereas the sections represent a portion of the trip ensured by a vehicle of the considered transportation mode, on a line that connects two stations. The physical environment represents the network as it exists with its physical characteristics in real-life for the vehicles. The tracks constitute the sections of the pathway, of the rail and more generally sections of all of the physical elements of a transport network suitable for the movement of a vehicle; besides, junctions between the different tracks are ensured by a set of interchanges which connect together the path sections, or bifurcations or railroad switches which connect together the sections of railroads, and more generally of physical elements that allow linking together different sections. According to this implementation mode, the simulation 102 applies the different rules that the vehicle shall apply and the constraints that it shall comply with to achieve its mission. According to the logical point of view, the simulation determines where and when the vehicle shall stops, for how much time it shall wait at each stop, the authorized delay, etc. According to the physical point of view, the simulation determines the section or the railroad switch that it shall follow, the speed that it shall observe.

The simulation of the interactions of the vehicle with the physical infrastructure of the line on which it circulates takes into account the constraints related to the traffic such as for example the density of the road traffic, the safety rules, in particular for railways, the conformance with the traffic signs. These rules may be different from one transportation mode to another.

According to one implementation mode, the simulation 102 of the future state is carried out based on a passenger-itinerary of each passenger of each transportation mode; the passenger-itinerary comprises a passenger-destination and is determined during the simulation step 102 so as to assign an itinerary to each passenger as a function of the state of the network at the considered time, and as a function of the passenger-profile of the passenger, that is to say for example according to an assumption on the distribution of the passengers at a given hour between different profiles.

According to one implementation mode, the itineraries are assigned to the sets of passengers waiting at each station of the multimodal network, according to a so-called multimodal dynamic assignment procedure, well known to those skilled in the art: according to this procedure, for each station of the multimodal network, one or several itinerar(y/ies), between this station considered as a start station and any one of the other stations of the network, considered as a destination station, are assigned to the set of passengers present on the network at this start station, including the additional stream estimated according to the data of the start-destination matrix, so that the transit time is generally optimum for this set of passengers. This procedure comprises three steps, applied successively and iteratively, for each possible pair formed by a departure station, or star station, of a transportation mode and an arrival station, or destination station, of the same transportation mode or of another transportation mode:

1. a first step of calculating a transit time, for all possible itineraries between the start station and the destination station, the transit time of each of the itineraries being determined as a function of the traffic conditions on the multimodal network at this step of the procedure;

2. a second step of determining a distribution of all passengers present on the network at the start station, including the additional stream according to the data of the start-destination matrix, over the different possible itineraries, the distribution being carried out as a function of the calculated transit times;

3. a third step of simulating the consequences of the determined distribution on the traffic conditions on the multimodal network, so as to determine new traffic conditions on the network.

These three steps are repeated so as to converge towards:
a distribution of all of the passengers present on the network at the start station, and
corresponding traffic conditions on the network,

which are optimum meaning that the transit time is generally at minimum for the set of considered passengers.

Thus, according to one implementation mode, a future state, for example in one hour, is forecasted every 5 minutes for example, based on the current state at this time point, that is to say based on the lastly gathered field data, in particular based on the numbers of passengers waiting at the different stations, the numbers of passengers onboard the different vehicles, and on the streams of additional passengers who will come into the network over the forecast period according to the indications of the start-destination matrix, which allows determining an assumption on the distribution of the passengers per passenger-profile and per passenger-destination, this distribution assumption being, according to this embodiment, predetermined for each transportation mode.

After having simulated at the simulation step 102, in a fine and detailed manner, for example according to a one-second step, the evolution, for example over one hour, of the determined current state towards a simulated future state of each transportation mode of the multimodal network, the method 100 comprises a step 103 of assessing at least one performance indicator based on the simulated future state of each transportation mode.

According to one implementation mode, the at least one performance indicator comprises at least one of the indicators amongst punctuality, regularity, occupancy rate, waiting time, trip duration.

According to one implementation mode, the punctuality indicator enables the operator of the network to assess, over the simulation period, the advance or the delay of the vehicles with regards to the check-in times scheduled by the operator.

According to one implementation mode, the regularity indicator enables the operator of the network to assess, over the simulation period, the estimated interval between the vehicles that circulate along the same itinerary and to compare this interval with a nominal interval.

According to one implementation mode, the occupancy rate indicator enables the operator to assess, over the simulation period, the comfort of the passengers by comparing this estimated occupancy rate or load with a nominal occupancy rate or load.

According to one implementation mode, the waiting time indicator enables the operator of the network to assess, over the simulation period, the estimated average waiting time of the passengers at each station of the network.

According to one implementation mode, the trip duration indicator enables the operator of the network to assess the average trip duration between a departure station and an arrival station.

The method comprises a step of determining 104 at least one regulatory action on at least one transportation mode of the multimodal network, as a function of the assessment 103 of the at least one indicator. According to one implementation mode, the at least one regulatory action comprises, for example, at least one of the actions amongst:
add a vehicle,
modify an itinerary of a vehicle to go from one station to another station of the transportation mode,
modify a check-in time of the at least one vehicle at a station of the plurality of stations,
close a station for a while,
set up a replacement bus,
close a section for a while,
reduce the rate,
add a station, and
delete a stop.

According to one implementation mode, each regulatory action results in modifying, at least virtually in a first step, the operating conditions of the considered transportation mode, and more specifically the service offering, the timetable in particular. Thus, the new simulation 105 step will generate a new future state; a new step of assessing 106 the at least one performance indicator of the transportation mode based on the new future state, followed by a step of comparing 107 the result of the new assessment and of the previous assessment of the at least one performance indicator will allow determining whether the performance indicator has improved.

The method repeats 108 steps of determining 104 at least one regulatory action, of new simulation 105, of new assessment 106 and of comparison 107 until a result of the comparison 107 indicates an improvement of the at least one performance indicator, in other words until the regulatory actions have a satisfactory predicted effect on the performance indicator(s).

If the regulatory actions turn out to have a satisfactory predicted effect on the performance indicator(s), then these actions may be implemented by the operator of the multimodal network, so as to effectively improve the performance of the network in accordance with the determined indicators.

Thus, according to these arrangements, the method allows assisting the operator of the multimodal network to better plan his multimodal mobility offering to better respond to the dynamic evolution of the mobility streams, thereby allowing improving the overall punctuality of the service, while considering the viewpoint of the passenger (an arrival time optimized for the passenger rather than a departure/arrival time of the transport vehicle scheduled by the operator), while enabling the operator to test the impact of different regulatory scenarios on the mobility system.

According to one implementation mode, the simulation of the future state and the new simulation of the new future state are carried out based on a vehicle-itinerary and on a vehicle-behavior model of each vehicle.

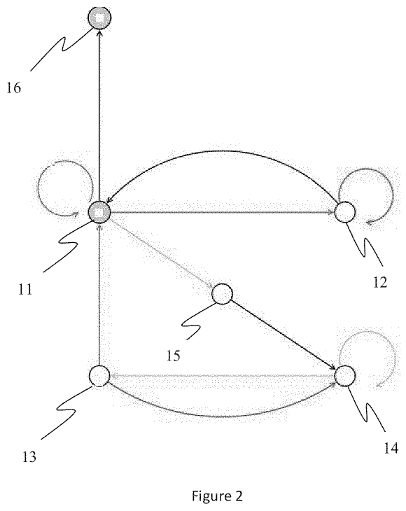

According to one implementation mode, illustrated in FIG. 2, the vehicle-behavior model of a vehicle is defined by a plurality of states of the vehicle, also called vehicle-state, and by vehicle-state change rules for making the vehicle switch from an initial vehicle-state into a next vehicle-state of the plurality of vehicle-states of said vehicle.

According to one implementation mode, the plurality of vehicle-states of the at least one vehicle comprises one of the vehicle-states amongst:
vehicle at stop by a signal 12,
vehicle moving 11,
vehicle at stop by a station 15,
vehicle being loaded 14,
vehicle being closed 13,
vehicle arrived at the terminus 16.

According to one embodiment, the vehicle-state change rules of a vehicle of a transportation mode comprise the safety rules and the rules for determining the displacement speed.

According to one implementation mode, the state change rules are those described in the table hereinbelow, with reference to FIG. 2:

| | | | Next state of the |
|---|---|---|---|
| Rule | Description | State of the vehicle | vehicle |
| move | allows attempting to | « At stop by a | « At stop by a |
| | make the vehicle | signal » | signal »: the vehicle |
| | advance physically | or | detects an object |
| | if the state allows | « moving » | signaling a |
| | so. | | requirement for |
| | | | unintended |
| | | | stoppage. The |
| | | | vehicle remains in |
| | | | this state as long as |
| | | | the considered |
| | | | object emits a |
| | | | different signal. |
| | | | « At stop by a |
| | | | station »: the vehicle |
| | | | detects a stop at |
| | | | which it shall stop |
| stop | allows stopping at | « At stop by a | « Loading » |
| | the next station to | station » | |
| | be visited. | | |
| embark | allows performing a | « Loading » | The vehicle will |
| passengers | selection of the | | remain in the |
| | passengers who | | « loading » state as |
| | wish to get into the | | long as its waiting |
| | vehicle (that is to | | time is not zero. |
| | say if the itinerary | | Several phenomena |
| | supposes so) and | | are involved in the |
| | who will actually | | calculation of the |
| | come into the latter | | waiting time. There |
| disembark | allows performing a | « Loading » | may be a minimum |
| passengers | selection of the | | stop time, a soonest |
| | passengers who | | departure time or an |
| | wish to get out of | | inadvertent blocking |
| | the vehicle (that is | | of the doors. This |
| | to say if the itinerary | | time will enable it to |
| | supposes so) and | | select passengers to |
| | who will actually | | disembark and then |
| | clear the latter | | embark. Once this |
| wait | allows decrementing | « Loading » | time falls to 0, a |
| | the necessary | | departure and doors |
| | waiting period | | closure attempt is |
| | (related to the | | performed by the |
| | schedule or to the | | Close-Doors rule, |
| | minimum waiting | | setting the vehicle in |
| | time) of the vehicle | | the « closing » state |
| Close doors | attempts a doors | « closing » | The vehicle will |
| | closure operation | | switch back into the |
| | depending on the | | « loading » state in |
| | feedback of the | | the case where it is |
| | check-up of the | | not possible to |
| | objects in front of | | advance (an object |
| | the vehicle | | in the physical |
| | | | infrastructure |
| | | | prevents its |
| | | | advance) modeling |
| | | | the fact that the |
| | | | doors remain open; |
| | | | the vehicle remains |
| | | | by the platform. |
| restart | enables the vehicle | « closing » | « moving » |
| | to switch back into | | |
| | the movement | | |
| | mode, if closure of | | |
| | the door has been | | |
| | complete | | |

According to one implementation mode, the itinerary of a vehicle, also called vehicle-itinerary, comprises a subset of stations of the plurality of stations of the considered transportation mode, the subset of stations comprising a departure station, intermediate stations, a terminus station and, optionally, at least one intermediate itinerary for going from one station of the subset of stations to the station.

According to one implementation mode, the simulation of the future state and the new simulation of the new future state are carried out based on a behavior model of the passengers, herein called passenger-behavior, of the transportation mode.

According to one implementation mode, a passenger refers to a group of passengers who have the same profile, as indicated hereinbefore, and who travel together through the transport network.

According to one implementation mode, the behavior model of the passengers is defined by a plurality of states of the passengers, herein called passenger-state, and by at least one passenger-state change rule to make said passenger switch from one passenger-state into a next passenger-state.

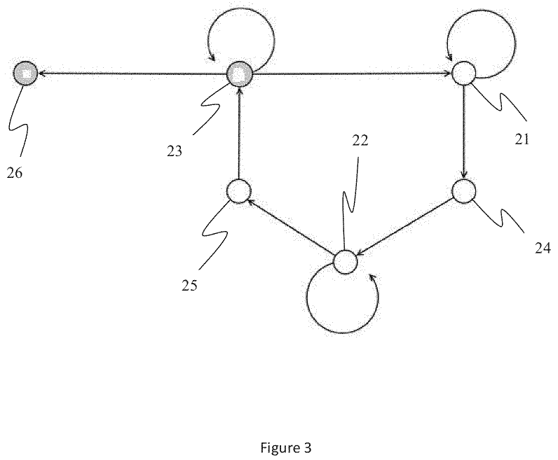

According to one implementation mode, illustrated in FIG. 3, the plurality of passenger-states comprises one of the passenger-states amongst:
waiting at station 21,
onboard 22,
walking in transit 23,
getting onboard 24,
descending 25,
arrived at destination 26.

According to one implementation mode, the at least one passenger-state change rule are those described in the table hereinbelow, with reference to FIG. 3:

| | | State of the | Next state of the |
|---|---|---|---|
| Rule | Description | passenger | passenger |
| Embark | enables the | « Waiting at | « Embarking »: the |
| | passenger or the | station » | passenger remains |
| | group of passengers | | in this transitional |
| | to physically get into | | state until the expiry |
| | the vehicle | | of a predetermined |
| | | | embarking time |
| Disembark | enables the | « onboard » | « Disembarking »: |
| | passenger or the | | the passenger |
| | group of passengers | | remains in this |
| | to get out of the | | transitional state |
| | vehicle in which | | until the expiry of a |
| | he/they was/were | | predetermined |
| | | | disembarking time |
| Move from | enables the group of | « Walking in | « Walking in |
| one station to | passengers to move | transit » | transit »: the group |
| another | in the network from | | of passengers may |
| | one station to | | perform any |
| | another. | | progression on foot |
| | | | through |
| | | | connections, while |
| | | | keeping this state |
| | | | until it decides to get |
| | | | into a vehicle at a |
| | | | station. It will then |
| | | | switches into a |
| | | | « Waiting at |
| | | | station » state. Once |
| | | | the passenger no |
| | | | longer has stations |
| | | | or connections to |
| | | | visit, he will then |
| | | | switch into an |
| | | | « arrived at |
| | | | destination » final |
| | | | state. |
| | | « Getting onboard » | « onboard »: he will |
| | | | remain in this state |
| | | | as long as the |
| | | | vehicle is not in the |
| | | | station. |
| | | « Descending » | The passenger |
| | | | accesses a station |
| | | | and thus continues |
| | | | his itinerary by |
| | | | switching back into |
| | | | the « Walking at |
| | | | transit » state |

1. A method for determining at least one performance indicator of a transport network, the transport network being used by a plurality of passengers of the network and the transport network comprising at least one transportation mode, each transportation mode of the at least one transportation mode comprising at least one vehicle and a plurality of stations, a start station of the plurality of stations of the at least one transportation mode being connected by a plurality of itineraries, each itinerary of the plurality of itineraries comprising a list of intermediate stations of the plurality of stations, to a destination station of the plurality of stations, a timetable of the at least one transportation mode defining a check-in time of the at least one vehicle at the start station, at the destination station, and at each station of the list of intermediate stations of the itinerary, the plurality of passengers of the network comprising, for each station of the plurality of stations of the at least one transportation mode, a number of passengers waiting at the station, the number of passengers waiting at the station being determined from data captured by at least one data collection instrument, a start-destination matrix defining, for a period of time, and for a pair formed by the start station and the destination station, an additional number of passengers who will come into the network via the start station, over the period of time, to join the destination station,
the method comprising the following steps:
for each transportation mode of the at least one transportation mode,
determination of a current state of the transportation mode defined for a current time within the period of time;
simulation of a future state, for a future time, of the transportation mode based on the current state, and of the additional number of passengers who will come into the network over the period of time according to the start-destination matrix;
assessment of the at least one performance indicator based on the future state of the transportation mode;
determination of at least one regulatory action on the at least one transportation mode as a function of the assessment of the at least one indicator;
new simulation of a new future state, for the future time, based on the current state, for the current time, and on the additional number of passengers who will come into the network over the period of time according to the start-destination matrix;
new simulation of the at least one performance indicator of the transportation mode based on the new future state;
comparison of the result of the new assessment and of the assessment of the at least one performance indicator;
repetition of the steps of determination of at least one regulatory action, of new simulation, of new assessment and of comparison until a result of the comparison indicates an improvement of the at least one performance indicator,
the simulation of the future state and the new simulation of the new future state being respectively carried out, for at least one intermediate time between the current time and the future time, by distributing over the plurality of itineraries joining the start station and the destination station, according to a predetermined distribution procedure, the number of passengers waiting at said start station to join said destination station, added to the estimated additional number, for said start station and for a period of time including the at least one intermediate time, based on the start-destination matrix.

2. The determination method according to claim 1, wherein the predetermined distribution procedure is carried out based on a passenger-profile associated to each passenger of the plurality of passengers waiting at said start station, and as a function of an intermediate state of the network defined at the intermediate time.

3. The determination method according to claim 2, wherein a passenger-itinerary is associated to each passenger of the plurality of passengers waiting at said start station, the passenger-itinerary being determined as a function of the passenger-profile.

4. The determination method according to claim 1, wherein the predetermined distribution procedure is a multimodal dynamic assignment procedure.

5. The determination method according to claim 1, wherein the at least one data collection instrument is a sensor, or a statistical data learning application, or a remote tickets purchase ticketing application.

6. The determination method according to claim 1, wherein the current state of the transportation mode is defined by at least one parameter, the at least one parameter comprising one amongst:
a number of passengers waiting at the stations of the plurality of stations of the transportation mode,
a position and a load of the at least one vehicle of the transportation mode,
a distribution by passenger-profile, of the number of passengers waiting at the stations of the plurality of stations of the transportation mode,
and wherein a value is determined by the at least one data collection instrument, or estimated, for each parameter of the at least one parameter, at the determination step.

7. The determination method according to claim 6, wherein the passenger-itinerary comprises a list of stations, each station of said list being a station of the plurality of stations of the at least one transportation mode, and each station of said list being determined as a function of the check-in time of the at least one vehicle of each transportation mode of the at least one transportation mode at the stations of the plurality of stations of each transportation mode of the at least one transportation mode, and so as to optimize the check-in time at the passenger-destination, and as a function of the passenger-profile.

8. The determination method according to claim 1, wherein the at least one transportation mode comprises at least one of the transportation modes amongst the transportation modes: by road, by rail, by air, by inland waterways, by sea.

9. The determination method according to claim 1, wherein the at least one performance indicator of the transportation network comprises at least one of the indicators: punctuality, regularity, occupancy rate, waiting time, trip duration.

10. The determination method according to claim 1,
wherein the at least one regulatory action of the transportation mode comprises at least one of the actions amongst:
add a vehicle,
modify an itinerary of a vehicle to go from one station of the plurality of stations to another station of the plurality of stations of the transportation mode,
modify a check-in time of the at least one vehicle at a station of the plurality of stations,
close a station for a while,
set up a replacement bus,
close a section for a while,
reduce the rate,
add a station, and
delete a stop.

11. The determination method according to claim 1, wherein the simulation of the future state and the new simulation of the new future state is carried out based on a vehicle-itinerary and on a vehicle-behavior model of the at least one vehicle,
and wherein the vehicle-behavior model of the at least one vehicle is defined by a plurality of vehicle-states of the at least one vehicle and by at least one vehicle-state change rule to make the at least one vehicle switch from an initial vehicle-state into a next vehicle-state of the plurality of vehicle-states of the at least one vehicle,
and wherein the vehicle-itinerary of the at least one vehicle comprises a subset of stations of the plurality of stations of the transportation mode of the at least one transportation mode, the subset of stations comprising a departure station, intermediate stations, a terminus station and, optionally, at least one intermediate itinerary to go from one station of the subset of stations to the station.

12. The determination method according to claim 11,
wherein the plurality of vehicle-states of the at least one vehicle comprises one of the vehicle-states amongst:
vehicle at stop by a signal,
vehicle moving,
vehicle at stop by a station,
vehicle being loaded,
vehicle being closed,
vehicle arrived at the terminus,
and wherein the at least one vehicle-state change rule of the at least one vehicle comprises at least one safety rule and at least one rule for determining a displacement speed.

13. The determination method according to claim 1, wherein the simulation of the future state and the new simulation of the new future state is carried out based on a passenger-behavior model of the plurality of passengers of the transportation mode,
the passenger-behavior model of the plurality of passengers being defined by a plurality of passenger-states of the at least one passenger and by at least one passenger-state change rule for making the at least one passenger switch from an initial state into a next state of the plurality of passenger-states of the plurality of passengers.

14. The determination method according to claim 13, wherein the transport network comprises at least one connection between a transportation mode and another transportation mode of the at least one transportation mode, the connection being defined by a connection station of the plurality of stations of the transportation mode of the at least one transportation mode, towards another connection station of the plurality of stations of the other transportation mode of the at least one transportation mode,
and wherein the plurality of passenger-states of the at least one passenger comprises one of the passenger-states amongst:
waiting at station,
onboard,
walking in transit,
boarding,
descending,
arrived at destination,
and wherein, optionally, the at least one passenger-state change rule of the at least one passenger comprises at least one walking speed determination rule conditioned by the passenger-profile of the at least one passenger.

15. The determination method according to claim 2, wherein the predetermined distribution procedure is a multimodal dynamic assignment procedure.

16. The determination method according to claim 3, wherein the predetermined distribution procedure is a multimodal dynamic assignment procedure.

17. The determination method according to claim 16, wherein the at least one data collection instrument is a sensor, or a statistical data learning application, or a remote tickets purchase ticketing application.

18. The determination method according to claim 17, wherein the current state of the transportation mode is defined by at least one parameter, the at least one parameter comprising one amongst:
a number of passengers waiting at the stations of the plurality of stations of the transportation mode,
a position and a load of the at least one vehicle of the transportation mode,
a distribution by passenger-profile, of the number of passengers waiting at the stations of the plurality of stations of the transportation mode,
and wherein a value is determined by the at least one data collection instrument, or estimated, for each parameter of the at least one parameter, at the determination step.

19. The determination method according to claim 18, wherein the passenger-itinerary comprises a list of stations, each station of said list being a station of the plurality of stations of the at least one transportation mode, and each station of said list being determined as a function of the check-in time of the at least one vehicle of each transportation mode of the at least one transportation mode at the stations of the plurality of stations of each transportation mode of the at least one transportation mode, and so as to optimize the check-in time at the passenger-destination, and as a function of the passenger-profile.

20. The determination method according to claim 19, wherein the at least one transportation mode comprises at least one of the transportation modes amongst the transportation modes: by road, by rail, by air, by inland waterways, by sea.
